(19) United States
(12) Patent Application Publication
(10) Pub. No.: US 2004/0247013 A1
(43) Pub. Date: Dec. 9, 2004

(54) Calibration device for a dental furnace

(76) Inventors: Daniel P. Clark, Stamford, CT (US); George Zychek, Stratford, CT (US)

Correspondence Address: PENTRON CORPORATION, 53 NORTH PLAINS INDUSTRIAL ROAD, WALLINGFORD, CT, 06492, US

(21) Appl. No.: 10/846,772

(22) Filed: May 14, 2004

Related U.S. Application Data
(60) Provisional application No. 60/470,457, filed on May 14, 2003.

(51) Int. Cl. G01K 15/00

(52) U.S. Cl. 374/1

(57) ABSTRACT

A calibration device for a dental furnace includes a meltable element located on a hollow tube. The melting of the meltable element breaks the seal and reduces the vacuum pressure in the furnace thereby triggering the controller to calibrate the temperature of the furnace to the melting temperature of the meltable element. Alternatively, a calibration device comprises a solid tube having a groove thereon is positioned in the furnace and a metal strip is positioned on the solid tube. Upon melting of the metal strip, the solid tube is displaced and the seal is broken allowing air from the external environment to access the furnace atmosphere. The change in vacuum pressure is detected and the temperature in the furnace and the melting point of the metal strip is used as the reference temperature to calibrate the furnace.

### CROSS-REFERENCE TO RELATED APPLICATIONS

This application claims priority to U.S. Application No. 60/470,457 filed May 14, 2003, entitled Calibration of Dental Furnaces.

### FIELD OF THE INVENTION

This invention relates to the temperature calibration of dental furnaces used in the dental laboratory.

### BACKGROUND OF THE INVENTION

Temperature calibration of a dental laboratory furnace can be a time consuming and complicated procedure. Methods of calibration include using manual calibration procedures based on the known melting temperatures of silver or gold. The operator determines the temperature by running a program or calibration procedure and observing the metal test sample (usually silver). The furnace temperature may have to be adjusted many times until the temperature is observed to be at the melting point of the metal used. This temperature is then used to set the calibration temperature of the furnace.

U.S. Pat. No. 6,384,382 discloses a calibration device that uses a series of metal posts and a meltable wire received in the posts. It is preferred that the posts are fabricated of platinum and the meltable wire is silver or gold. The requirement of platinum posts increases the cost of the device.

Other methods use the loss of electric current in a metal test wire to detect the melting point of the metal and adjust the calibration accordingly. Problems with accuracy, electrical connections, and material interactions pose problems with this method.

It would be desirable to provide a simplified automated temperature calibration system. It would be beneficial to reduce the amount of noble metals used in the system to minimize costs.

### SUMMARY OF THE INVENTION

The calibration device herein is removably located in a dental furnace and includes a meltable element located on a hollow tube. The tube is positioned in the furnace such that one end is present in the vacuum atmosphere created in the furnace and the other end is linked to the external atmosphere. The meltable element is positioned and sealed on the end of the hollow tube that is present in the furnace atmosphere. The melting of the meltable element breaks the seal and reduces the vacuum pressure in the furnace thereby triggering the controller to calibrate the temperature of the furnace to the melting temperature of the meltable element.

In another embodiment herein, a solid tube having a groove thereon is positioned in the furnace and a metal strip is positioned on the solid tube. The metal strip maintains the solid tube in place. The vacuum atmosphere in the furnace is sealed from the external atmosphere. One end of the solid tube is positioned in the furnace in the sealed vacuum atmosphere and the other end is coupled to a spring. Upon melting of the metal strip, the solid tube is displaced and the seal is broken allowing air from the external environment to access the furnace atmosphere. The change in vacuum pressure is detected and the temperature in the furnace and the melting point of the metal strip is used as the reference temperature to calibrate the furnace.

The calibration devices described herein may used in dental porcelain and dental pressing furnaces.

### BRIEF DESCRIPTION OF THE DRAWINGS

Features of the present invention are disclosed in the accompanying drawings, wherein similar reference characters denote similar elements throughout the several views, and wherein:

FIG. 1 is an partial elevational view of a calibration device positioned in a furnace;

FIG. 2 is an elevational view of a furnace with the calibration device positioned therein;

FIG. 3 is a partial schematic diagram of a calibration device positioned in a furnace;

FIG. 4 is a partial enlarged view of the calibration device positioned in a furnace; and

FIG. 5 is a diagram showing the control circuit connections to the heater, vacuum pump, vacuum sensor, and temperature sensor.

### DESCRIPTION OF THE INVENTION

Dental furnaces incorporate a vacuum/heating chamber commonly known as a muffle. Dental furnaces showing vacuum or heating chambers are set forth in U.S. Pat. Nos. 6,252,202, 6,180,922, 6,488,074, 5,266,777, 4,702,696, and 4,272,670 which are hereby incorporated by reference.

This invention uses the melting point of a known metal, such as, but not limited to a nobel metal, preferably, but not limited to, silver, gold or platinum, which is used in any manner to seal a vacuum port of the muffle. A control circuit operatively connected to a vacuum source turns on the vacuum source, which creates a vacuum in the muffle. The controller raises the temperature of the muffle with a calibration device inside.

In one embodiment herein, the calibration device consists of a metal with a known melting point, such as silver, that is positioned so as to seal the vacuum port. The temperature in the furnace is raised to the point where the metal melts. As it melts, the vacuum port seal opens, and the vacuum level change is detected by the controller. The temperature calibration is then performed using the melting point of the reference metal.

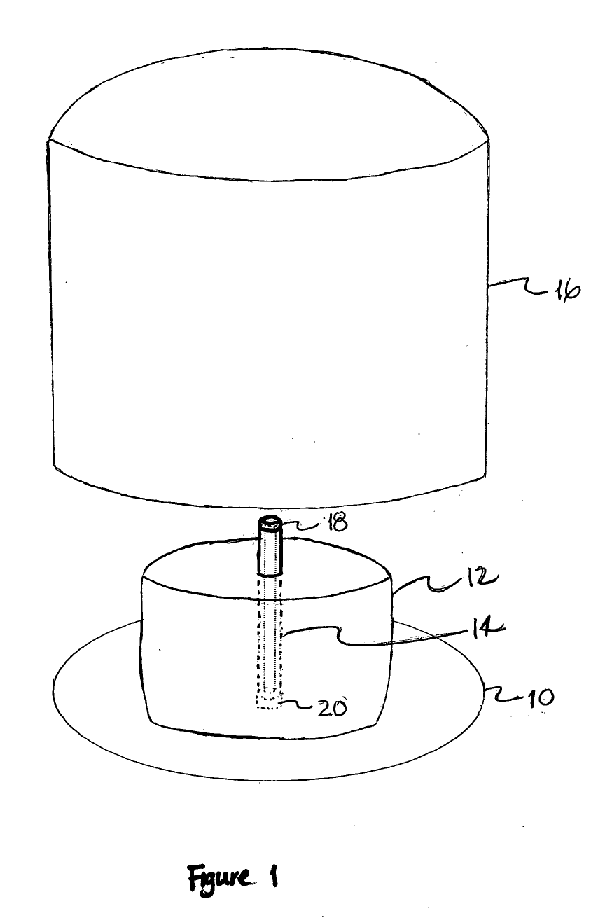

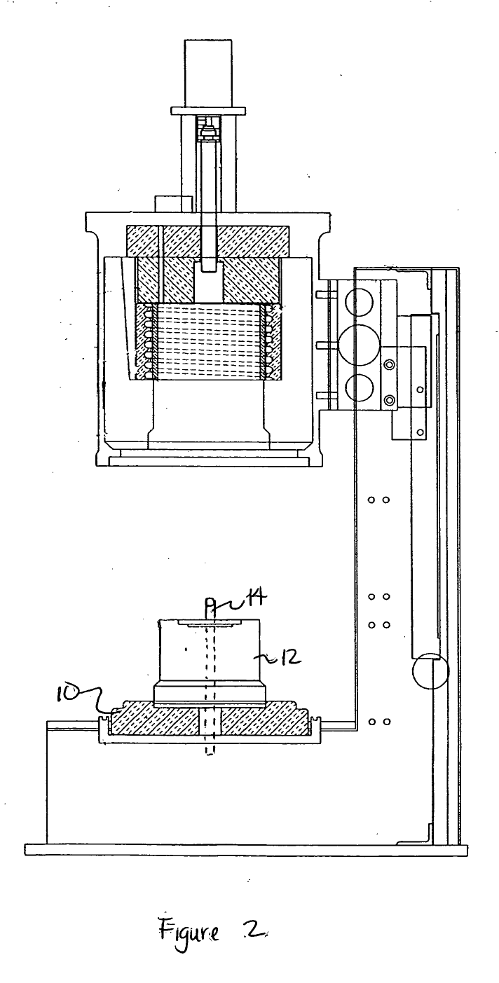

FIG. 1 shows a furnace platform 10 upon which a firing base 12 is placed. Both platform 10 and firing base 12 include slots or openings for inserting a tube 14 therein. Tube 14 is disposed in firing base 12 and extends through platform 10 as more clearly shown in FIG. 2. Lower end of tube 14, which extends past platform 10 is exposed to the atmosphere. Lower end of tube 14 is vented to the outside atmosphere below platform 10 at vent port 20. A metal seal 18 is positioned on one end of tube 14 and is sealed to tube 14 by any known method including, but not limited to, press fitting the metal plug into the tube inner diameter end to create a seal, press fitting tube outer diameter into a metal formed seal, or drawing or casting a melted metal into a tube opening to fill one end of the tube. Metal seal 18 seals tube 14 such that the outside atmosphere is prevented from entering into the furnace atmosphere. As shown in the drawing, the tube is positioned vertically, wherein the upper end extends into the furnace atmosphere when the muffle is closed and is sealed from the external atmosphere, and the lower end is shown extending from the furnace and exposed to the external atmosphere.

Depending on the design of the furnace, tube 14 may be positioned in any direction as long as one end is disposed in the furnace and the other end extends to and area outside the furnace atmosphere.

Although it is preferred that silver, having a melting point of approximately 962° C. is the metal used herein, any metal useful for this purpose may be used. Tube 14 may be fabricated of any high temperature resistant material such as, but not limited to, a ceramic or metal. Examples of ceramic materials useful herein include, but are not limited to, refractory-type materials such as mullite, quartz, cristobolite, silica, leucite, alumina, zirconia, magnesia, zircon, aluminosilicate, cordierite, mica, and mixtures thereof.

Muffle 16 is shown above firing platform 10 in open position. To use the calibration device herein, the muffle is closed and a vacuum atmosphere is created. The temperature in the furnace is raised. As the temperature increases, the tube is heated until the melting point of the metal is reached. When the melting point of the metal is attained, the metal melts, releasing the seal it had formed, and the vacuum atmosphere in the furnace is exposed to the outside atmosphere from the lower end of tube 14. As the vacuum pressure drops, a controller operatively coupled to the vacuum sensor detects the drop in vacuum pressure, and uses the melting point of the metal to adjust the offset temperature factor for a temperature calibration.

In an alternate embodiment, the vent port can also be operatively connected to a vacuum switch. As the metal melts, the seal is broken and the atmosphere in the furnace is exposed to atmospheric pressure. As the vacuum pressure drops in the furnace, the vacuum switch is activated. The vacuum switch is activated due to a change in the vacuum level in the furnace. The control circuit operatively connected to the vacuum switch uses the signal to detect the melting point of the metal seal and calibrates the temperature based on the melting temperature of the metal.

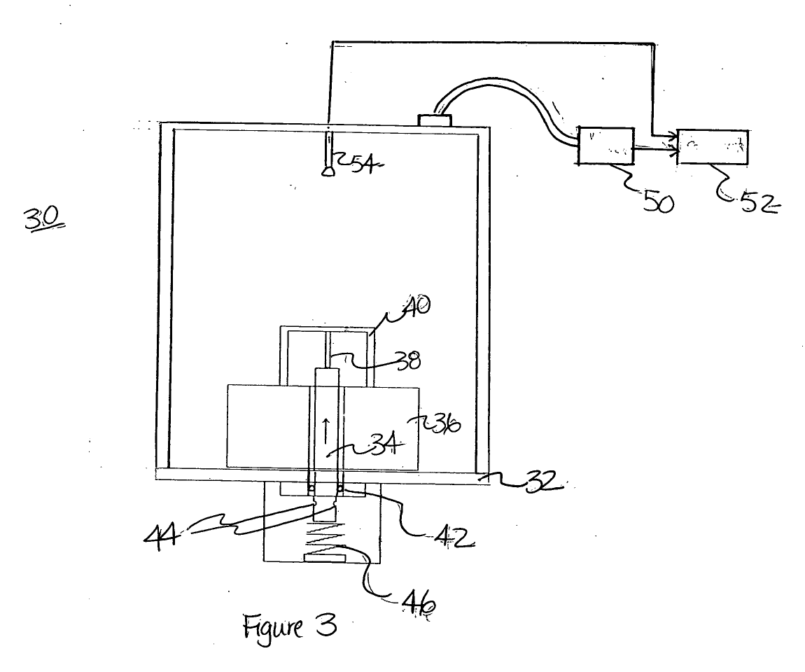

FIG. 3 shows yet another embodiment. A furnace arrangement 30 comprises a furnace platform 32. A solid tube 34 is located in firing base 36 and extends through furnace platform 32. A metal strip 38 is positioned atop solid tube 34. Metal strip 38 may be in any shape or form such as, but not limited to, square, rectangular, oblong, cylindrical, spherical shape. A holder 40 maintains metal strip 38 in place on top of solid tube 34. Holder 40 may be of any material able to withstand the high temperatures of the furnace such as, but not limited to, those materials used to make the tube as described above. Below furnace platform 32, an O-ring or similar sealing element 42 is positioned around solid tube 34 to seal the vacuum atmosphere in the furnace from the external atmosphere. Solid tube 34 contains a groove, channel or similar element 44 disposed a short distance from the lower end of solid tube 34. Positioned below solid tube 34 is a spring 46. Solid tube 34 is positioned on spring 46 so that spring 46 is not fully compressed.

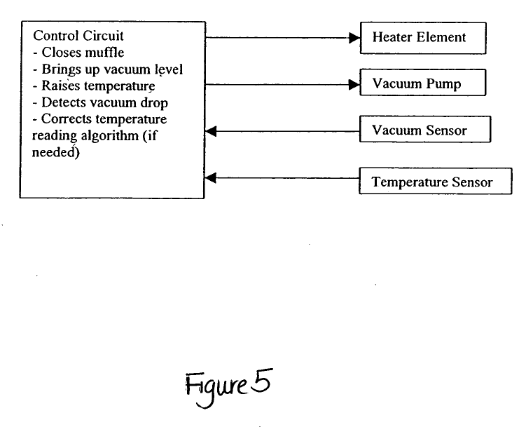

A vacuum sensor 50 is operatively associated with the internal atmosphere in the furnace to detect any change in the vacuum pressure. Vacuum sensor 50 may be any known device, such as, but not limited to Sensym SCX15ANC available from SensorTechnics, Inc. A controller 52 is operatively associated with the vacuum sensor, vacuum pump, temperature sensor such as thermocouple 54 and a heater element. FIG. 5 is a diagram showing the control output and control input of the control circuit. The operation begins by closing the muffle. The control circuit sends a signal to the vacuum pump to turn on the vacuum and sends a signal to the heater element to raise the temperature. After a period of time, the vacuum sensor senses a vacuum decrease and the controller corrects the temperature by comparing the current temperature to the melting point temperature of the metal strip.

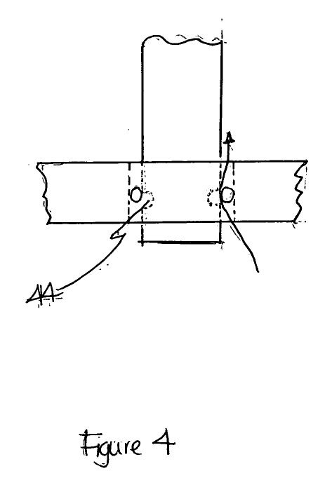

The operation of the calibration device is as follows. The temperature in the furnace is increased until the metal strip begins to melt. As the metal strip melts, the solid tube is displaced upward. As the tube travels upward, the groove therein reaches the O-ring, at which point the seal from the external atmosphere is broken and air is allowed to travel through the opening created at the groove in the solid tube. FIG. 4 shows the solid tube as it contacts the O-ring and breaks the seal. The arrow depicts the movement of air from the external atmosphere. The vacuum pressure drops and the detector operatively connected to the furnace detects the drop in pressure. The controller calibrates the temperature of the furnace based on the melting temperature of the metal.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

1. A calibration device for placement in a dental furnace having a vacuum atmosphere and for calibrating the temperature of the dental furnace comprising:
a tube having a first end and an second end; and
a metal seal located on the first end of the tube.

2. The calibration device of claim 1 wherein the metal seal is meltable upon heating of the dental furnace to a certain temperature and wherein melting of the metal seal effects a change in the atmosphere in the furnace.

3. The calibration device of claim 2 wherein the change in the atmosphere in the furnace comprises a change in the vacuum pressure in the atmosphere in the furnace.

4. The calibration device of claim 2 wherein the change in the atmosphere in the furnace triggers the furnace to calibrate the temperature of the dental furnace.

5. The calibration device of claim 1 wherein the metal seal is meltable upon heating of the dental furnace to a certain temperature and wherein melting of the metal seal breaks the seal of the tube and reduces the vacuum pressure in the atmosphere in the furnace.

6. The calibration device of claim 1 wherein the metal seal is fabricated of a noble metal.

7. The calibration device of claim 1 wherein the metal seal is fabricated of a metal comprising gold, silver, platinum or a mixture thereof.

8. The calibration device of claim 1 wherein the tube is fabricated of a high temperature resistant material.

9. The calibration device of claim 8 wherein the high temperature resistant material comprises mullite, quartz, cristobolite, silica, leucite, alumina, zirconia, magnesia, zircon, aluminosilicate, cordierite, mica, and mixtures thereof.

10. A calibration device for placement in a dental furnace for calibrating the temperature of the dental furnace comprising:
a tube having a first end and a second end; and
a metal seal located on the first end of the tube;
wherein the metal seal is meltable upon heating of the dental furnace to a certain temperature and wherein melting of the metal seal effects a change in the atmosphere in the furnace.

11. A calibration device for placement in a dental furnace comprising a vacuum atmosphere and for calibrating the temperature of the dental furnace comprising:
a tube having a first end and a second end; and
a metal seal located on the first end of the tube;
wherein the metal seal is meltable upon heating of the dental furnace to a certain temperature and wherein melting of the metal seal effects a change in the atmosphere in the furnace;
wherein the change in the atmosphere in the furnace comprises a change in the vacuum pressure of the atmosphere in the furnace.

12. A dental furnace comprising:
a muffle for firing dental porcelain;
a vacuum port located in the muffle to provide a vacuum atmosphere;
a tube having a first end and an second end, wherein the first end is positioned in the muffle and the lower end is exposed to the atmosphere;
a metal seal located at the first end of the tube; and
a vacuum sensor for detecting a drop in the vacuum atmosphere in the muffle.

13. The dental furnace of claim 12 wherein the metal seal is meltable upon heating of the dental furnace to a certain temperature and wherein melting of the metal seal effects a change in the atmosphere in the furnace.

14. The dental furnace of claim 12 wherein the change in the atmosphere in the furnace comprises a change in the vacuum pressure in the atmosphere in the furnace.

15. The dental furnace of claim 12 wherein the change in the atmosphere in the furnace triggers the furnace to calibrate the temperature of the dental furnace.

16. The dental furnace of claim 12 wherein the metal seal is meltable upon heating of the dental furnace to a certain temperature and wherein melting of the metal seal breaks the seal of the tube and reduces the vacuum pressure in the atmosphere in the furnace.

17. The dental furnace of claim 12 wherein the metal seal is fabricated of a noble metal.

18. The dental furnace of claim 12 wherein the metal seal is fabricated of a metal comprising gold, silver, platinum or a mixture or alloy thereof.

19. The dental furnace of claim 12 wherein the tube is fabricated of a high temperature resistant material.

20. The dental furnace of claim 19 wherein the high temperature resistant material comprises metal or ceramic.

21. The dental furnace of claim 19 wherein the high temperature resistant material comprises mullite, quartz, cristobolite, silica, leucite, alumina, zirconia, magnesia, zircon, aluminosilicate, cordierite, mica, or mixtures thereof.

22. The dental furnace of claim 12 further comprising a vacuum switch which is triggered when the metal seal is broken.

23. A method for calibrating a dental furnace comprising:
placing a calibration device in the furnace, wherein the calibration device comprises a tube having a first end and an second end, and a metal seal located on the first end of the tube, wherein the first end is positioned in the furnace and the second end is exposed to the atmosphere;
creating a vacuum atmosphere in the furnace;
increasing the temperature of the furnace;
detecting a decrease in the vacuum;
sensing the temperature at which the vacuum decrease is detected; and
calibrating the temperature of the furnace based on the temperature at which the vacuum decrease occurred.

24. The method of claim 23 wherein the increase in temperature causes the metal seal to melt, wherein the melting of the metal seal breaks the seal on the tube, and wherein the breaking of the seal decreases the pressure of the vacuum in the furnace.

25. A dental pressing furnace comprising:
a muffle for firing dental porcelain;
a vacuum port located in the muffle to provide a vacuum atmosphere;
a plunger that extends into muffle for pressing the dental porcelain;
a tube having a first end and a second end, wherein the first end is positioned in the muffle and the second end is exposed to the atmosphere;
a metal seal located at the first end of the tube; and
a controller for detecting a drop in the vacuum.

26. The dental furnace of claim 25 wherein the metal seal is meltable upon heating of the dental furnace to a certain temperature and wherein melting of the metal seal effects a change in the atmosphere in the furnace.

27. The dental furnace of claim 26 wherein the change in the atmosphere in the furnace comprises a change in the vacuum pressure in the atmosphere in the furnace.

28. The dental furnace of claim 26 wherein the change in the atmosphere in the furnace triggers the furnace to calibrate the temperature of the dental furnace.

29. The dental furnace of claim 25 wherein the metal seal is meltable upon heating of the dental furnace to a certain temperature and wherein melting of the metal seal breaks the seal of the tube and reduces the vacuum pressure in the atmosphere in the furnace.

30. A method for calibrating a dental pressing furnace comprising:
placing a calibration device in the furnace, wherein the calibration device comprises a tube having a first end and a second end, and a metal seal located on the first end of the tube, wherein the first end is positioned in the furnace and the second end is exposed to the atmosphere;
creating a vacuum in the furnace;
increasing the temperature of the furnace;
detecting a decrease in the vacuum;
sensing the temperature at which the vacuum decrease is detected; and
calibrating the temperature of the furnace based on the temperature at which the vacuum decrease occurred.

31. The method of claim 30 wherein the increase in temperature causes the metal seal to melt, wherein the melting of the metal seal breaks the seal on the tube, and wherein the breaking of the seal decreases the pressure of the vacuum in the furnace.

32. A calibration device for placement in a dental furnace having a vacuum atmosphere and for calibrating the temperature of the dental furnace comprising:
a solid tube having a first end and a second end;
a metal strip located on the first end of the tube; and
a holder maintaining the metal strip in place.

33. The calibration device of claim 32 wherein the solid tube comprises a groove or channel around the periphery of the tube.

34. The calibration device of claim 32 wherein the metal strip is formed into a square, rectangular, oblong, cylindrical or spherical shape.

35. The calibration device of claim 32 wherein the metal strip is meltable upon heating of the dental furnace to a certain temperature and wherein melting of the metal seal effects a change in the atmosphere in the furnace.

36. The calibration device of claim 35 wherein the change in the atmosphere in the furnace comprises a change in the vacuum pressure of the atmosphere.

37. The calibration device of claim 35 wherein the change in the atmosphere in the furnace triggers the furnace to calibrate the temperature of the dental furnace.

38. The calibration device of claim 32 wherein the metal strip is meltable upon heating of the dental furnace to a certain temperature and wherein melting of the metal strip creates a decrease in the vacuum in the atmosphere.

39. The calibration device of claim 32 wherein the metal strip is fabricated of a noble metal.

40. The calibration device of claim 39 wherein the noble metal comprises gold, silver, platinum or a mixture or alloy thereof.

41. The calibration device of claim 32 wherein the solid tube is fabricated of a high temperature resistant material.

42. The calibration device of claim 41 wherein the high temperature resistant material comprises ceramic or metal.

43. The calibration device of claim 42 wherein the ceramic comprises mullite, quartz, cristobolite, silica, leucite, alumina, zirconia, magnesia, zircon, aluminosilicate, cordierite, mica, or mixtures thereof.

44. The calibration device of claim 32 wherein the dental furnace is a pressing furnace.

45. The calibration device of claim 32 wherein the holder is fabricated of a high temperature resistant material.

46. The calibration device of claim 45 wherein the high temperature resistant material comprises ceramic or metal.

47. The calibration device of claim 46 wherein the ceramic comprises mullite, quartz, cristobolite, silica, leucite, alumina, zirconia, magnesia, zircon, aluminosilicate, cordierite, mica, or mixtures thereof.

48. A calibration device for placement in a dental furnace comprising a vacuum atmosphere and for calibrating the temperature of the dental furnace comprising:
a solid tube having a first end and a second end;
a metal strip located on the first end of the tube; and
a holder maintaining the metal strip in place;
wherein the metal strip is meltable upon heating of the dental furnace to a certain temperature and wherein melting of the metal strip effects a change in the atmosphere in the furnace.

49. A dental furnace comprising:
a muffle for firing dental porcelain;
a vacuum port located in the muffle to provide a vacuum atmosphere;
a solid tube having a first end and a second end, wherein the first end is positioned in the muffle and sealed from the atmosphere and wherein the second end is exposed to the outside atmosphere;
a metal strip located at the first end of the solid tube; and
a vacuum sensor for-detecting a drop in the vacuum.

50. The dental furnace of claim 49 further comprising a holder to maintain the metal strip in place.

51. The dental furnace of claim 49 further comprising a sealing component disposed around the solid tube to maintain the vacuum in the muffle.

52. The dental furnace of claim 51 further comprising a spring operatively associated with the solid tube.

53. The dental furnace of claim 49 wherein when the temperature of the furnace reaches a certain temperature, the metal strip melts and the solid tube is lifted upwardly by action of the spring, breaking the seal from the outside atmosphere.

54. The dental furnace of claim 49 wherein the dental furnace is a pressing furnace.
